(19) United States
(12) Patent Application Publication
(10) Pub. No.: US 2026/0228507 A1
(43) Pub. Date: Aug. 6, 2026

(54) Strategic Distribution of AI Inference Processing in Distributed Computing Environments

(71) Applicant: James Olivier, Dallas, TX (US)

(72) Inventor: James Olivier, Dallas, TX (US)

(21) Appl. No.: 19/320,590

(22) Filed: Sep. 5, 2025

Related U.S. Application Data
(60) Provisional application No. 63/753,688, filed on Feb. 4, 2025.

(51) Int. Cl. G06N 3/0475; G06N 5/04

(52) U.S. Cl. CPC G06N 3/0475; G06N 5/04

(57) ABSTRACT

The present disclosure provides a method for performing generative AI inference computations in a distributed computing environment. The method includes receiving from a user device a message requesting generative AI model output at a first computing device at a first location. The first computing device selects a second location based on criteria, then generates a second message containing information from the received message or derived information. The first computing device sends the second message to the second location, where it serves as input to a generative AI inference system operating on a second computing device. The second computing device executes the generative AI inference system to generate output, which is sent to the user device.

### RELATED APPLICATIONS

This application claims priority under 35 U.S.C. § 119(e) of U.S. Provisional Patent Application Ser. No. 63/753,688 (Attorney Docket No. 9163.00001) filed on Feb. 4, 2025 and titled Strategic Distribution of AI Inference Processing in Distributed Computing Environments. The content of this application is incorporated herein by reference

### FIELD OF THE INVENTION

The present invention relates to systems and methods for a distributed computing environment for Artificial Intelligence (“AI”) applications in a distributed manner.

### BACKGROUND

The term “generative AI” refers to a class of artificial intelligence models, systems, and operations designed to create new content, such as text, images, music or video based on the patterns learned from existing data. Unlike traditional AI models that seek to classify input data, generative AI models produce new original outputs from user provided inputs. As the output is new, these models are termed generative AI.

Types of generative AI models vary and include a wide range of inputs and outputs. Generative models outputs can include image generation, where models such as DALL-E, Midjourney, Stable Diffusion, etc. create images from textual descriptions, Natural language processing, where models such as GPT-4 generate comprehensible text or code from input text and other model types which create music or video from user inputted text, images or video.

A generative AI model can, for example, convert, input image to text, input text to image, input text to video, input text to speech, or input image to input video. These generative AI models typically make use of an embedding which translates the user input into a multi-dimensional vector upon which the generative AI model operates to generate an output.

Before a generative AI model can be made operational it must first be trained. The training phase can take months and require large amounts of both energy, data and computing power. Once the model has been trained so that its generated output quality meets predetermined thresholds, it can be made operational. The operational generative AI model can then be used to take user input and produce original outputs. The process of using a trained AI model to generate original outputs is known as inference.

The training and inference phases of generative AI models typically take place in a data center. Data centers generally comprise virtual machines running on hardware servers owned by the data center provider such as a Microsoft or a Google. This allows data center providers to rent computing facilities to multiple customers. Typically, data center providers rent virtual machines to their customers to execute their software applications on. These virtual machines run on various hardware servers within a data center. A data center's customer may rent virtual machines to run their software applications, as web servers or AI models, on. Data centers may also rent AI services directly to a customer. This is known as software as a service, SAAS, which allows their customers to develop AI applications using built in capabilities within the data center. In either case the entirety of AI computations take place within the provider's data center.

If all the computations of the generative AI model take place within a data center, the developer of the generative AI model is restricted in many ways. The developer is restricted to a single data center provider, limiting flexibility in choosing computing resources based on cost, performance, or availability. The generative AI model's reliability and availability is restricted to the reliability and availability of the provider's data center, creating potential single points of failure. Moreover, the developer of the generative AI model is also restricted in their ability to determine what energy sources used to power their AI model. They are therefore unable to mitigate the environmental impact of their generative AI model by using alternative energy sources.

This limitation becomes more significant in the execution of generative artificial intelligence inference models. Though much attention has been given to the environmental impacts of training AI models due to their energy cost, the energy costs of inference may be even larger in some cases. If a particular generative AI model becomes popular, the energy costs of inference execution may exceed that of training the model. This centralized approach also limits the ability to leverage geographically distributed computing resources that may offer advantages such as reduced latency for users in different regions, access to renewable energy sources in specific locations, or utilization of computing resources during off-peak hours in different time zones.

Furthermore, the centralized model creates dependencies on the infrastructure and policies of a single provider, which may not align with the specific requirements or preferences of the AI model developer. This includes limitations on the types of hardware available, the geographic locations where computations can be performed, and the energy sources powering the computations. The inability to distribute AI inference computations across multiple locations also reduces opportunities for customer defined load balancing, fault tolerance, and optimization based on real-time conditions such as energy availability, computing capacity, or network performance.

The centralized approach may also limit the potential for utilizing stranded energy resources-energy that is produced but cannot be efficiently transported or sold due to geographic or infrastructure constraints. These energy sources, which include renewable sources like solar, wind, and hydroelectric power in remote locations, as well as waste energy from industrial processes, represent untapped opportunities for powering AI computations while reducing environmental impact.

### SUMMARY OF THE INVENTION

Accordingly, there is a need to find alternative computing environments for the execution of the inference phase of generative AI models.

Embodiments disclosed herein describe systems and methods for performing generative AI inference computations in a distributed computing environment.

In accordance with a first aspect, the invention provides a method for performing generative AI inference computations in a distributed computing environment. The method comprises receiving from a user device a received message comprising a request to generate a generative AI model output response at a first computing device located at a first location and comprised by the distributed computing environment. The method further comprises selecting by the first computing device a second location based on one or more criteria. Responsive to selecting the second location, the method includes at least one of generating by the first computing device a second message comprising information from the received message, or generating by the first computing device the second message by deriving derived information from the received message and generating the second message comprising the derived information. The method also comprises sending the second message by the first computing device to the second location, providing the second message as an input to at least one of a generative AI inference system or a portion of a generative AI inference system operating on a second computing device located at the second location, generating a generated output by executing on the second computing device the at least one of the generative AI inference system or the portion of the generative AI inference system, and sending the generated output by the second computing device to the user device.

In some embodiments, the sending of the second message comprises passing the second message over a satellite communication system.

In some embodiments, the received message comprises at least one of text, tokenized text, images or speech.

In some embodiments, at least one criterion of the one or more criteria is one of a type of a power source at the second location, a geographical location of the second location, an available computing power amount at the second location, or a time of day.

In some embodiments, the selection is based in part by information provided to the user device by the user.

In some embodiments, the step of deriving derived information by the first computing device from the received message includes determining an embedding from the received message based on an embedding model, querying a data source based on the determined embedding for one or more vectors, and converting the one or more vectors to a sequence of text, wherein the derived information comprises the sequence of text.

In some embodiments, the second location utilizes a stranded energy power source to provide electrical power to the second computing device.

In some embodiments, the stranded energy power source utilizes at least one of electrical power from a battery, electric power generated by methane gas, electric power generated by solar cells, electric power generated by wind power or electric power generated by waterpower.

In accordance with another aspect, the invention provides a method for performing generative AI inference computations in a distributed computing environment comprising receiving from a user device a received message comprising a request to generate a generative AI model output response at a first computing device located at a first location and comprised by the distributed computing environment. The method further comprises selecting by the first computing device a second location based on one or more criteria, and responsive to selecting the second location, at least one of generating by the first computing device a second message comprising information from the received message, and generating by the first computing device the second message by deriving derived information from the received message and generating the second message comprising the derived information. The method also comprises sending the second message by the first computing device to the second location, wherein the second message is provided as an input to at least one of a generative AI inference system or a portion of a generative AI inference system operating on a second computing device located at the second location and comprised by the distributed computing environment.

In some embodiments, the sending of the second message includes sending the second message over a satellite communication system.

In some embodiments, the received message comprises at least one of text, tokenized text, images or speech.

In some embodiments, the selection is based in part by information provided to the user device by the user.

In some embodiments, at least one criterion of the one or more criteria is one of a type of a power source at the second location, a geographical location of the second location, an available computing power amount at the second location, or a time of day.

In some embodiments, the type of a power source at the second location is at least one of electrical power sourced from a battery, electric power generated by methane gas, electric power generated by solar cells, electric power generated by wind power or electric power generated by waterpower.

In accordance with another aspect, the invention provides a method for performing generative AI inference computations in a distributed computing environment comprising receiving a received message by a second computing device at a second location from a first computing device at a first location, the first and second computing devices comprised by the distributed computing environment, the received message being generated in response to a first computing system receiving from a user device a message comprising a request to generate a generative AI model output response. The method further comprises providing the received message as an input to at least one of a generative AI inference system or a portion of a generative AI inference system operating on the second computing device, generating a generated output by executing on the second computing device the at least one of the generative AI inference system or the portion of the generative AI inference system, and sending the generated output by the second computing device to the user device.

In some embodiments, the received message is received from a satellite communication system.

In some embodiments, the generated output comprises at least one of text, images or speech.

In some embodiments, the second computing device makes use of a stranded energy power source to provide electrical power to the second computing device.

In some embodiments, the stranded energy power source utilizes at least one of electrical power from a battery, electric power generated by methane gas, electric power generated by solar cells, electric power generated by wind power or electric power generated by waterpower.

Advantages of the system include one or more of the following. The distributed computing environment for computing generative AI allows for some or

the computation workload to be executed in alternative locations. The system can be made more reliable and efficient as the distributed computing environment for generative AI inference allows for the selection of different distinct computing resources based on a number of criteria. For example, if the amount of computing capacity at one location was insufficient due to a computer system failure or inadequate power, the system could select an alternative location. In this manner, the distributed generative AI computing environment may achieve higher reliability and availability than traditional approaches.

The use of the distributed computing environment also allows for generative AI models to be executed in alternative locations which allows for the use of alternative energy sources. The result of which may be a reduction of the environmental impact of executing generative AI inference computations.

### BRIEF DESCRIPTION OF THE DRAWINGS

For the purposes of illustrating the invention, there are shown in the drawing forms which are presently preferred, it being understood, however, that the invention is not limited to the precise arrangements and instrumentalities shown. Further features and advantages, as well as the structure and operation of various embodiments thereof, are described in detail below with reference to the accompanying drawings. The accompanying drawings which are incorporated in and constitute part of the specification are included to illustrate and provide a further understanding of the methods. Together with the description, the drawings explain the principles of the invention.

FIG. 1 depicts a prior art generative AI transformer-based model.

FIG. 2 depicts a distributed generative AI inference system according to an embodiment of the invention.

FIG. 3 depicts a remote location utilizing methane gas according to an embodiment of the invention.

FIG. 4 depicts a computer system software executing in a data center according to an embodiment of the invention.

FIG. 5 depicts a distributed generative AI inference system according to an embodiment of the invention.

FIG. 6 depicts a flowchart illustrating a method for performing generative AI inference computations in a distributed computing environment according to an embodiment of the invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Those of ordinary skill in the art realize that the following descriptions of the embodiments of the present invention are illustrative and are not intended to be limiting in any way. Other embodiments of the present invention will readily suggest themselves to such skilled persons having the benefit of this disclosure. Like numbers refer to like elements throughout.

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the invention.

Furthermore, in this detailed description, a person skilled in the art should note that quantitative qualifying terms such as “generally,” “substantially,” “mostly,” and other terms are used, in general, to mean that the referred to object, characteristic, or quality constitutes a majority of the subject of the reference. The meaning of any of these terms is dependent upon the context within which it is used, and the meaning may be expressly modified.

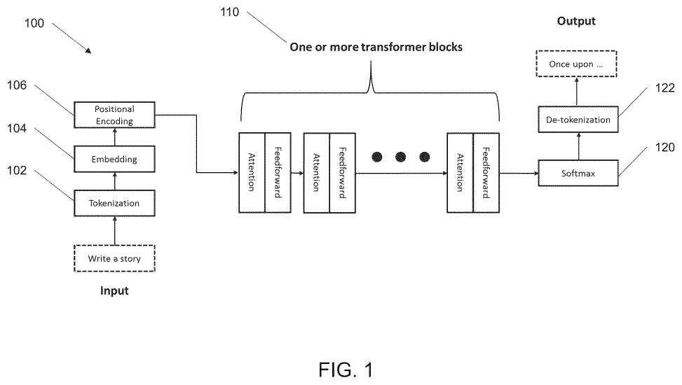

Referring now to FIG. 1, prior art AI model architecture 100 for a generative AI transformer-based model is presented. The first step in the development of a generative AI model is to determine the model's architecture and size. A model's architecture is a particular arrangement of the artificial neural network defining the model. An example of a model architecture for generative AI is the transformer model. Other types of model architectures include diffusion models, generative adversarial networks, neural radiance fields, mixture of experts and or combinations of different models known as hybrid models. Each of these types of models has a basic architecture associated with it. For example, the basic transformer model architecture is a combination of attention layers and feed-forward layers. Llama 3 is a particular type of transformer model architecture. In the transformer-based AI model architecture 100 of FIG. 1, there are six main tasks performed by respective software modules: tokenization 102, embedding 104, positional encoding 106, transformer blocks 110, softmax 120, and de-tokenization 122. Other AI models can have different architectures and a different set of operations.

Once the model's architecture is determined, the size of the generative AI model needs to be determined. The size of the generative AI model is the number of parameters or weights associated with the model. For example, Llama 3.2 models can have different sizes, such as 1 billion, 3 billion, 11 billion, or 90 billion parameters. Any sized model is contemplated and included within the scope of the invention.

After a generative AI model's architecture and size have been determined, it is trained for a particular task, e.g. text generation. Generative AI models can be trained for a number of tasks, such as acting as chatbots, text creation, document summarization, email assistance, product descriptions or language translation. The defined model goes through a training phase, for example the model could be trained using back propagation techniques to reduce the output error. After the AI model has reaches a state where the output error is sufficiently low, the output quality is determined to be sufficient and training is stopped.

After the generative AI system has been trained, it can be used to generate original output such as text or images in a process known as inference. The generative AI inference system first receives a message from a user device such as a computer or smartphone. This message can be a prompt typed in by the user or other text generated by the user's device. These other messages can be supplied by software running on the user's device. For example, this software can take the user's prompt and add additional text to improve the response by using prompt injection or supplying the chat history.

After the message is received, the trained generative AI inference system begins the process of analyzing the message and generating an output.

The first step of the process is tokenizing the input 102. In this step, the input is broken up into words, parts of words or punctuation, all which are found in the particular token library which was used in the training phase of the generative AI model. For example, the tokenizer for Llama 3 breaks the word, ‘stranded energy’ into three tokens, ‘str’, ‘anded’ and ‘energy’. These tokens are then converted into a number, known as a token ID through a lookup table. The three tokens ‘str’, ‘anded’ and ‘energy’ may be converted to the vector of three token IDs [496, 6601, 4907] by looking up each token in the lookup table. The size of the lookup table relates to the size of the vocabulary of the tokenizer and varies by different type of AI model. Different AI Models can have different vocabulary sizes, for example Llama 2 has a vocabulary size of around 32,000 while Llama 3 has a vocabulary size of around 128,000.

After tokenization 102 the individual tokens IDs are converted into high dimensional vector, known as an embedding 104. For Llama 3 this dimension is 4096. The value for ‘energy’, ‘4907’ is converted into vector of size 4096 when it goes through the process of embedding. This would produce a 1×4096 vector, with values ranging from −1 to 1. This vector along with the vectors for the other tokens are then fed into the positional encoding 106, one or more transformer blocks 110 and then to a softmax function 120 to produce a single output token, which is then de-tokenized into a word or portions of words. For example, when fed in the input text “Write a story” the trained AI model may produce the output token for the text ‘once’.

The output token may then be fed back into the trained AI model and the above processes is repeated recursively. In this manner the generative AI Inference system generates more and more output tokens. The tokens are de-tokenized as they are produced and returned back to the user's device as text. For example, when fed in the prompt “Write a story about” the generative AI Inference system may start to produce the output text string ‘once upon a time . . . ’. Finally, the generative AI inference system reaches a stopping condition and the recursive operations halt.

Retrieval augmented generation, ‘RAG’ makes use of a database to improve the results of the generated information from a generative AI inference system. This database is created prior to the user request by ingesting certain documents, first chunking them and then creating and storing embeddings for these chunks in a database, known as a vector database. The embedding model used for these embeddings could be the same model as was used for the generative AI inference system or it could be a different embedding model entirely.

In retrieval augmented generation, the information sent to the generative AI inference system includes extra information derived from querying a database, typically in the form of text or tokens created from the retrieved vectors.

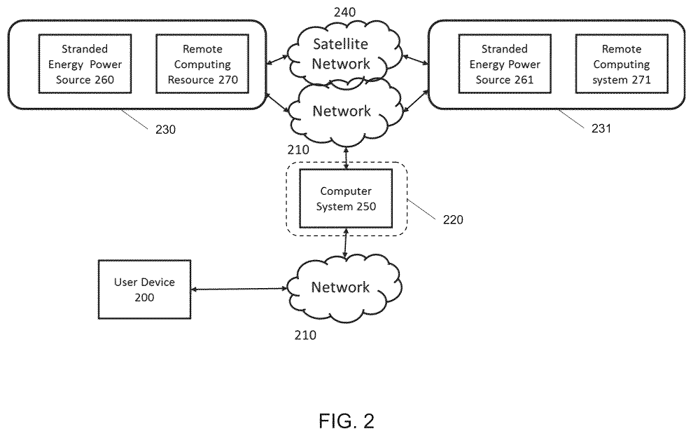

FIG. 2 shows a system for the execution of a generative AI inference system in a distributed computing environment according to an embodiment of the invention. User device 200 is a user computing device such as a smart phone, a desktop or laptop computer capable of executing software applications such as web browsers. The user inputs requests, for example, a text prompt to be processed by a particular generative AI inference system. As an example, the user may wish to use a Llama 3.2 model with a size of 90 billion parameters trained for document summarization. Computer software on the user device 200 may under certain conditions add additional information to the user request, such as the chat history or other relevant information, and then send this additional information along with the user's request as a message or messages to data center 220 over network 210.

Other users may be making use of different generative AI inference systems such as image generators or video generators. In these cases, the user device may send images, video or sound or text in any combination to data center 220.

Network 210 provides communication links between various computer processing entities. Network 210 may be made up of other networks such as the Internet and may include wired or wireless links, or fiber optic links. Network 210 allows for interconnectivity between the user's device and other computers around the world. Typically, these networks make use the TCP/IP protocol to send and receive information. Any type of network is contemplated and included within the scope of the invention, including, but not limited to, cellular networks, mesh networks, all wide area networks (such as the Internet), local area networks, and personal area networks. The user device 200 may include the necessary hardware components to accomplish such communication, such as a network communication device (not shown) to communicate across the network 210.

Data center 220 may be a large computing center such as, for example, a Microsoft Azure data center or a Google Data Center, containing multiple computer systems 250. Computer system 250 may comprise one or more virtual machines running on hardware servers within the data center. Data center providers allow multiple customers to rent computing facilities, such as virtual machines on which to execute their software applications. In this embodiment, users'messages will be received at one or more virtual machines running on hardware servers within computer system 250 located within data center 220.

Data center 220 connects to remote computing resources located in other cities, towns, or any other separate geographic location over a network. This could be through network 210 or through an additional network. For example, in one embodiment, a satellite network 240 such as Starlink® could be utilized to connect to remote locations 230 and 231. The use of a satellite network 240 allows the computer system 250 to send messages to remote locations 230 and 231 that may not be easily reachable through other communication networks. In some aspects, the connection between data center 220 and remote locations may utilize any suitable communication network type, including but not limited to terrestrial networks, satellite networks, microwave networks, fiber optic networks, wireless networks, or combinations thereof.

Remote locations 230 and 231 may comprise remote computing resource 270 for the execution of generative AI inference computations. For example, remote computing resource 270, 271, which may comprise an Nvidia® DGX SuperPOD® or Intel® Gaudi® 3 systems or combinations of each along with supporting computing infrastructure. These computing systems are capable of executing multiple generative AI inference computations at the same time. For example, an Nvidia® DGX SuperPOD® can contain up to 256 H 100 graphics processing units (GPUs) and is therefore capable of executing large number of generative AI inference computations simultaneously. Any number of GPUs of any model type may be comprised by the remote computing resources 270, 271.

Some efficiencies may be achieved if the tokenization of the user's message occurs at computer system 250 rather than at one or more of the remote computing resources 270, 271. In this case, only a portion of the generative inference computations are done utilizing one or more of the remote computing resources 270, 271. This distributed approach provides several advantages over performing all operations at the remote location. First, tokenization is typically a less computationally intensive operation compared to the embedding, transformer, and softmax operations, making it suitable for execution at the data center where network latency to the user device is minimized. Second, by performing tokenization at computer system 250, the tokenized data can be transmitted to the remote location in a more compact format, reducing bandwidth requirements over the satellite communication system. Third, this approach allows for preprocessing and validation of the user input before transmission to the remote location, enabling early detection of malformed requests or inappropriate content. Additionally, the computer system 250 can perform load balancing decisions based on the tokenized input characteristics, such as sequence length or complexity, to select the most appropriate remote computing resource for the remaining inference operations. This hybrid distribution of computational tasks optimizes both network efficiency and computational resource utilization across the distributed system.

Remote Locations 230, 231 also may comprise stranded energy power sources 260 and 261. Stranded energy refers to energy that is produced but cannot be efficiently used, transported, or sold due to various constraints. This represents an inefficiency where usable energy exists but remains untapped for various reasons. One reason is that these resources are often located in remote or inaccessible areas, where the infrastructure necessary to connect them to the electrical grid or transport them is either too expensive to build or technically unfeasible. As a result, the energy produced in these locations goes to waste, often with environmental consequences.

For example, large natural gas reserves might be discovered in a remote region with no nearby markets or pipelines to transport the gas to where it is needed. Similarly, hydroelectric plants might be located in remote mountainous regions where the energy they produce cannot be easily transmitted over long distances due to the lack of high-voltage transmission lines.

Renewable energy sources like solar and wind power can become stranded as well. In some regions, particularly those with high renewable energy potential, such as the deserts of North Africa or the plains of the United States, the energy generated by solar panels or wind turbines cannot be utilized as there may be no connection to the electrical grid at these remote locations. Tidal power and remote hydroelectric dams are another energy source which may be stranded due to lack of connectivity to the electrical grid. Low Earth orbiting satellite's solar panels can also represent a stranded energy resource.

A common example of stranded energy is the natural gas that is produced as a byproduct of oil production in remote oil fields. If remote oil fields have no infrastructure to capture, store and transport this gas, it is often burned off in a process known as flaring. This not only represents a significant waste of energy but also contributes to greenhouse gas emissions.

In this embodiment, these stranded energy power sources are converted to the electrical power needed to operate the remote locations 230, 231 by way of an electrical power generation system. These stranded energy power sources may also store excess electrical energy in batteries for times when the stranded energy sources are unavailable, such as nighttime in the case of a solar powered stranded energy power source.

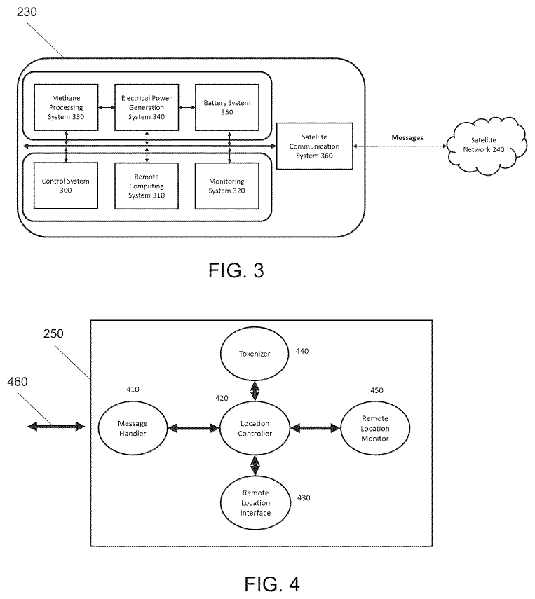

FIG. 3 shows a remote location 230 according to an embodiment of the invention, where the stranded energy power source utilized is methane gas. A methane processing system 330 captures and processes the methane gas and then stores it for use by a methane generator (not shown). An electrical power generation system 340 uses the stored methane gas to produce electrical power by way of the methane generator. Other facilities in the electrical power generation system 340 may transform the generated electricity to the voltage and wattage required by other components in the remote location such as a remote computing system 310, a control system 300 and a monitoring system 320. The remote location 230 may further comprise a battery system 350 operable to store electrical power onsite in case of electrical power grid disconnection and/or to timeshift electrical power drawn from an electrical power grid, which can be employed to store power when such electrical power is available at a lower price and using the stored power when electrical power is at a higher price. The battery system 350 may also store electrical power generated from stranded energy power source 260 as described above.

The monitoring system 320 may be operable to monitor the remote location for various parameters, such as amount of available power, available backup power, temperature, humidity, and available computing power. The monitoring system 320 may also monitor the methane processing system 330 and the voltage and amperage produced by the methane generator. The health of the battery storage system 350, total electrical energy produced, and other parameters could also be monitored. This information may be sent back over the satellite communication system for analysis and storage. By way of example, this information may be used to apply for Certified Emission Reduction credits monitored by the European Union. In such as case the relevant information should be archived electronically and be kept at least for two years after the end of the last crediting period.

The control system 300 maintains and controls the remote location by performing such tasks as gathering data, receiving requests from the computer system 250 and supervising systems such as the remote computing system 310 and the methane processing system 330. The control system 300 also interfaces with the monitoring system 320 to report important data back to computer system 250. The control system 300 also is used to update or modify the software executing on the remote computing system 310 when needed. For example, when a new or updated generative AI inference system is to be made operational at this remote location, it would be the control system 300 which is responsible for downloading, updating and installing the generative AI inference systems at this remote location.

The operation of the distributed generative AI inference system begins with the user making a request to a particular generative AI inference system. The user inputs a request, for example a text prompt and supplies it as input to software such as an application or a web browser executing on the user's device.

The user's device may add additional information to the user request. This additional information may be in the form of additional text in the case of prompt engineering or other information generated by software running on the user's device.

As shown in FIG. 3, the information provided by the user and any additional information provided by the software executing on the user's device is then combined into one or more messages and sent to a computer system 250 in a data center 220.

At data center 220, the user's message or messages are routed to the appropriate computer system 250, typically a number of virtual machines executing software tasks. Referring now additionally to FIG. 4, a computer systems 250 having software stored and executed thereon according to an embodiment of the invention. A message handler software 410 may be operable to receive the user's messages 460 and determine the particular generative AI inference system requested by the user's device. Based on availability of the requested AI inference system and other criterion, such as that provided by a remote location monitor 420, a remote location interface 430 may determine a remote location containing the remote computing system to be used. The criteria for the determination can include the type of stranded energy utilized at a remote location as described above, the amount of available power at a remote location, the amount of available computing power available at a remote location, and the time of day or the geographical location of a remote location.

A message or messages may then be generated by the computer system 250 to be sent 460 to the selected remote location based in part on the received message from the user's device. If the received message or messages have not already been tokenized, they may be tokenized based on a generative AI model that may have been requested by the user by a tokenizer 440. This information can be packaged in one or more messages along with other information generated by computer system 250 and sent 460 to the selected remote location.

The one or more messages can be sent 460 to the remote location by making use of a satellite communication network as shown and described in FIG. 2 above. At the remote location the message or messages may be received by way of satellite communication system 360 and provided to the remote computing system 310.

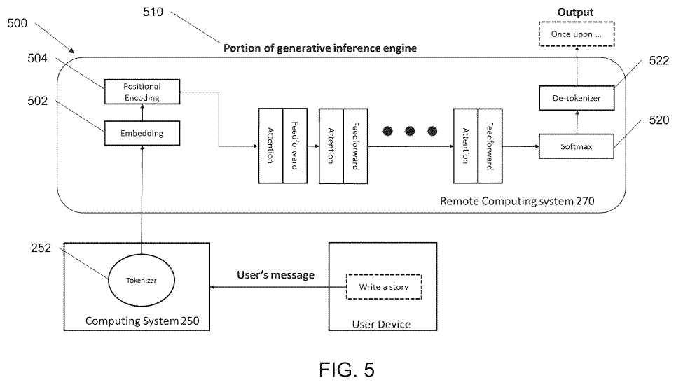

The one or more messages are first received by the satellite communications system 360. Under control of the control system 300, the one or more messages are transferred to the correct instance of a selected generative AI inference system. The information in the one or more messages is provided as input to the selected generative AI inference system executing on remote computing system 310. The information is then processed by the generative AI inference system. If the message information has already been tokenized, the generative AI processing will skip this task. FIG. 5 shows a distributed generative AI inference system 500 where the tokenizer in computing system 250 performs the tokenization operation 252 while the other generative AI operations are performed by remote computing system 310 according to an embodiment of the invention. The system 500 further comprises software modules configured to perform embedding 502, positional encoding 504, transformer blocks 510, softmax 520, and de-tokenization 522 tasks similar to the system 100 of FIG. 1.

After the generative AI tasks are complete, output text will be generated by remote computing system 310 and sent back to the user in messages. These messages may pass through computing system 250 or be sent directly back to user device 200. This process will continue until a stopping condition has been met. At this point control system 300 may be notified by remote computing system 310 that additional computing resources are now available.

Control system 300 may then inform remote location monitor 420 residing in computer system 250 that additional computing resources are now available at this location. In a similar manner, if control system 300 detects a loss of computing facilities or available power, it can inform software running in computer system 250. In this manner, a distributed generative AI inference system can achieve higher reliability and availability than traditional approaches.

While the above described techniques provide significant advantages, the following portions provide for extensions and variants of these techniques. For example, the operation of the distributed generative AI Inference systems described herein can be readily be modified to provide for text for retrieval augmented generation.

In this extension, prior to user messages being received at computing system 250, certain relevant documents are ingested to create one or more vector databases for computing system 250. The creation of vector databases can be done by computing system 250 or at another computing facility. In the case of the latter, the vector data may be stored locally at computing system 250. If the vector data is not stored locally, the vector databases should be accessed remotely by computing system 250.

After receiving a message or messages from the user's device at data center 220, if this information was not already tokenized, the message is tokenized. Next, based on the tokenized message, an embedding vector is determined based on an embedding model. The embedding model used to create this embedding vector need not be the same embedding model used by the user requested AI model.

This embedding vector is then used to query vector databases to retrieve one or more vectors. The one or more vectors retrieved from the vector databases are then converted into a sequence of text which is known as a context. This context may be combined with other information by computing system 250 to create a message or messages to be sent to a selected remote location.

The operation proceeds as described above with the created message sent to the selected remote location. This message is processed by remote computing resource 270 and the produced output is then returned to the user's device.

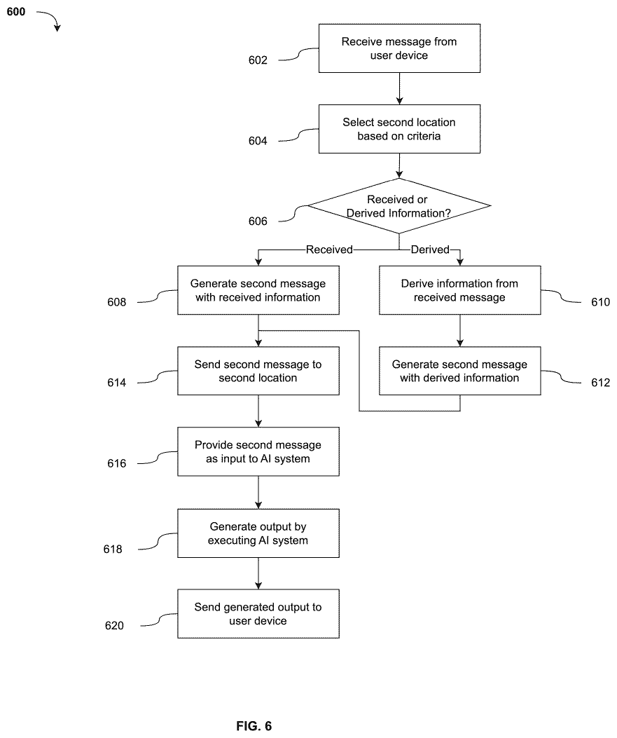

FIG. 6 illustrates a flowchart for a method 600 of performing generative AI inference computations in a distributed computing environment. The method 600 begins with step 602, where a message is received from a user device. In step 604, a second location is selected based on one or more criteria. The criteria for selecting the second location may include the type of power source at the second location, the geographical location of the second location, the available computing power amount at the second location, the time of day, user-provided preferences, network latency considerations, energy costs, environmental impact factors, regulatory compliance requirements, and/or the specific computational requirements of the requested generative AI inference system.

The method 600 proceeds to a decision point 606 that determines whether to use received or derived information. The decision criteria may include, but are not limited to: the complexity of the user request, the availability of vector databases for retrieval augmented generation, the computational capacity at the first computing device, network bandwidth limitations between locations, the type of generative AI model being utilized, security requirements for data processing, latency constraints for real-time applications, and the specific nature of the requested AI inference task.

If using received information, the process moves to step 608, where a second message is generated with received information. Alternatively, if using derived information, the process goes to step 610, where information is derived from the received message, followed by step 612, where a second message is generated with the derived information. The derived information may be generated through various methods including: determining embeddings from the received message using embedding models, querying vector databases based on the determined embeddings to retrieve relevant context vectors, converting retrieved vectors into sequences of text for context augmentation, performing tokenization operations on the received message, applying retrieval augmented generation techniques to enhance the input with additional relevant information, or executing preprocessing algorithms to optimize the data format for transmission to remote computing resources. The generation process may involve real-time embedding computations, database query operations, text conversion algorithms, or combinations thereof depending on the selected generative AI inference system requirements and the available computational resources at the first computing device.

Both paths converge at step 614, where the second message is sent to the second location. In step 616, the second message is provided as input to at least one of a generative AI inference system or a portion of a generative AI inference system operating on the second computing device. The AI systems contemplated may include various types of generative AI models and architectures. In some aspects, the AI system may comprise transformer-based models such as those utilizing the architecture shown in FIG. 1, including models similar to GPT-4, Llama 3, or Llama 3.2 with varying parameter sizes ranging from 1 billion to 90 billion parameters or more. The AI systems may also include diffusion models for image generation, generative adversarial networks, neural radiance fields, mixture of experts models, or hybrid models that combine different architectural approaches.

The input provision process may involve feeding the second message to specific components of the AI system architecture. In some embodiments, if tokenization has already been performed at the first computing device as shown in FIG. 5, the input may be provided directly to the embedding module 502, bypassing the tokenization step. The input may then flow through the positional encoding module 504, transformer blocks 510, softmax module 520, and detokenization module 522 as appropriate for the specific AI model being executed. In cases where retrieval augmented generation is employed, the input may include both the original user request and additional context information derived from vector database queries, allowing the AI system to generate more informed and contextually relevant outputs.

The method 600 continues with step 618, where output is generated by executing the AI system, and concludes with step 620, where the generated output is sent to the user device.

The description of the disclosure has been presented for purposes of illustration and is not intended to be exhaustive or limited to the disclosure in the form disclosed. Many modifications and variations will be apparent to those of ordinary skill in the art. For example, one of skill in the art would recognize that the data centers described in the above embodiments could be replaced by any sufficiently powerful computing system or that the satellite communications network described above could be replaced by a point to point microwave communications network. In addition, while some of the given components of the system have been described separately, one of ordinary skill will appreciate that some of the functions may be combined into programs or shared in given instructions, program sequences, code portions, and the like.

What is claimed is:

1. A method for performing generative AI inference computations in a distributed computing environment comprising the steps of:
receiving from a user device a received message comprising a request to generate a generative AI model output response at a first computing device located at a first location and comprised by the distributed computing environment;
selecting by the first computing device a second location based on one or more criteria;
responsive to selecting the second location, at least one of:
generating by the first computing device a second message comprising information from the received message; or
generating by the first computing device the second message by:
deriving derived information by the first computing device from the received message; and
generating by the first computing device the second message comprising the derived information;
sending the second message by the first computing device to the second location;
providing the second message as an input to at least one of a generative AI inference system or a portion of a generative AI inference system operating on a second computing device located at the second location and comprised by the distributed computing environment;
generating a generated output by executing on the second computing device the at least one of the generative AI inference system or the portion of the generative AI inference system; and
sending the generated output by the second computing device to the user device.

2. The method of claim 1 wherein sending the second message comprises passing the second message over a satellite communication system.

3. The method of claim 1 wherein the received message comprises at least one of text, tokenized text, images or speech.

4. The method of claim 1 wherein at least one criterion of the one or more criteria is one of, a type of a power source at the second location, a geographical location of the second location, an available computing power amount at the second location, or a time of day.

5. The method of claim 1 wherein the selection is based in part by information provided to the user device by the user.

6. The method of claim 1 where the step of deriving derived information by the first computing device from the received message comprises:
determining an embedding from the received message based on an embedding model;
querying a data source based on the determined embedding for one or more vectors; and
converting the one or more vectors to a sequence of text;
wherein the derived information comprises the sequence of text.

7. The method of claim 1 wherein the second location utilizes a stranded energy power source to provide electrical power to the second computing device.

8. The method of claim 7 wherein the stranded energy power source utilizes at least one of, electrical power from a battery, electric power generated by methane gas, electric power generated by solar cells, electric power generated wind power or electric power generated by waterpower.

9. A method for performing generative AI inference computations in a distributed computing environment comprising the steps of:
receiving from a user device a received message comprising a request to generate a generative AI model output response at a first computing device located at a first location and comprised by the distributed computing environment;
selecting by the first computing device a second location based on one or more criteria;
responsive to selecting the second location, at least one of:
generating by the first computing device a second message comprising information from the received message; and
generating by the first computing device the second message by:
deriving derived information by the first computing device from the received message; and
generating by the first computing device the second message comprising the derived information; and
sending the second message by the first computing device to the second location;
wherein the second message is provided as an input to at least one of a generative AI inference system or a portion of a generative AI inference system operating on a second computing device located at the second location and comprised by the distributed computing environment.

10. The method of claim 9 wherein the sending of the second message includes sending the second message over a satellite communication system.

11. The method of claim 9 wherein the received message comprises at least one of text, tokenized text, images or speech.

12. The method of claim 9 wherein the selection is based in part by information provided to the user device by the user.

13. The method of claim 9 wherein at least one criterion of the one or more criteria is one of, a type of a power source at the second location, a geographical location of the second location, an available computing power amount at the second location, or a time of day.

14. The method of claim 13 wherein the type of a power source at the second location is at least one of, electrical power sourced from a battery, electric power generated by methane gas, electric power generated by solar cells, electric power generated wind power or electric power generated by waterpower.

15. A method for performing generative AI inference computations in a distributed computing environment comprising the steps of:
receiving a received message by a second computing device at a second location from a first computing device at a first location, the first and second computing devices comprised by the distributed computing environment, the received message being generated in response to a first computing system receiving from a user device a message comprising a request to generate a generative AI model output response;
providing the received message as an input to at least one of a generative AI inference system or a portion of a generative AI inference system operating on the second computing device;
generating a generated output by executing on the second computing device the at least one of the generative AI inference system or the portion of the generative AI inference system; and
sending the generated output by the second computing device to the user device.

16. The method of claim 15 wherein the received message is received from a satellite communication system.

17. The method according to claim 15 wherein the generated output comprises at least one of text, images or speech.

18. The method of claim 15 wherein the second computing device makes use of a stranded energy power source to provide electrical power to the second computing device.

19. The method of claim 18 wherein the stranded energy power source utilizes at least one of, electrical power from a battery, electric power generated by methane gas, electric power generated by solar cells, electric power generated wind power or electric power generated by waterpower.
